(19) United States
(12) Patent Application Publication
(10) Pub. No.: US 2003/0092468 A1
(43) Pub. Date: May 15, 2003

(54) Combination thinline phone and PDA

(76) Inventor: Vaughn W. North, Sandy, UT (US)

Correspondence Address: Vaughn W. North, THORPE, NORTH & WESTERN, L.L.P., P.O. Box 1219, Sandy, UT, 84091-1219, US

(21) Appl. No.: 10/295,640

(22) Filed: Nov. 15, 2002

Related U.S. Application Data
(60) Provisional application No. 60/332,404, filed on Nov. 15, 2001.

(51) Int. Cl. H04B 1/38; H04M 1/00

(52) U.S. Cl. 455/556; 455/90; 455/550

(57) ABSTRACT

A combination cell phone and PDA device, comprising a primary housing for containment of a power source and primary control circuitry, including transmission and reception circuitry for a cellular telephone. The secondary housing includes a display screen and command input functions and circuitry for both telephone and PDA use. The primary housing also includes a receiving compartment configured for removable insertion of the secondary housing for storage during nonuse, thereby providing easy access for removal from the primary housing to access communication and processing features of the secondary housing for cell phone and PDA use.

The present invention claims priority of U.S. Patent Application S/ No. 60/332,404 filed Nov. 15, 2001 in the United States Patent and Trademark Office.

### FIELD OF THE INVENTION

This invention relates to personal digital assistant (PDA) devices that are integrated with cell phone units as a single, handheld device.

### BACKGROUND OF THE INVENTION

Cellular telephones have become commonplace in the communication industry and include configurations of virtually every shape, size and color. In addition, their economies of use have allowed the cell phone industry to operate even more cheaply than wire based systems. Undoubtedly, cell phones will continue to proliferate as a dominant mobile communication device.

A more recent technical innovation is the personal digital assistant or PDA. This device operates similarly to a computer for data processing, and provides visual data display on a small LCD or similar screen. Data entry is typically made by stylus pressure applied to the screen. New versions include Internet access through conventional telemetry circuits, providing wireless communications for email messaging and other forms of data transfer.

Size reduction considerations continue to impose limitations on both cell phone and PDA devices. The combined requirements of power supply, control circuitry, telemetry hardware, memory components, display screen, functional switches and input/output jacks create significant weight, as well as requiring a large housing. Although cell phones have succeeded in developing some miniaturization, PDA devices continue to be quite large and cumbersome. The large size has prompted belt-supported carriers incorporating a pocket that enables easy removal of the PDA for handheld use.

Cell phone and PDA technologies have also been merged into a single device in the form of smartphones that share common circuitry, display and power sources to supply the respective telephone and data processing functions. In this configuration, the weight and size of the combined devices are even more problematic, in view of the dual functions required to support both telephone and PDA processes. Despite the fact that such devices have increased weight, users appear to be willing to accept this inconvenience because of the simplicity of carrying a single device that performs the dual functions. Furthermore, the smaller size of the display screen as part of a cell phone imposes further limitations on the utility of the PDA functions in which the display screen provides data display and entry. For this and other reasons, popularity of smartphones has been somewhat marginal.

### SUMMARY OF THE INVENTION

The present invention is represented by a combination cell phone and PDA device, comprising (i) a primary housing for containment of a power source and primary control circuitry, and (ii) a secondary housing or console including a display screen and command input functions for both telephone and PDA use.

The primary housing includes a receiving compartment configured for removable insertion of the secondary housing for storage during nonuse, yet provides easy access for removal from the primary housing to access communication features of the secondary housing for cell phone use, as well as PDA functions.

A further embodiment of this invention includes a hinged junction in a midsection of the secondary housing dividing the secondary housing into upper and lower sections. A preferred configuration positions the display screen in the upper section and the telephone input functions in the lower section, allowing rotation of the lower section to an oblique angle with respect to the upper section.

The device is also characterized by laterally extending shoulders at upper sides of the upper section of the secondary housing configured to engage upper contacting edges of the primary housing to block full insertion into the compartment. This allows the console to be readily grasped and removed from the compartment. A window recess is formed at a forward face of the compartment and is configured to expose telephone speaker and microphone elements, as well as power controls enabling activation of the telephone on upon reception of a phone call.

An additional embodiment of the present invention provides for either wireless or hard-wired connection between the primary and secondary housings. Telemetry and receiver circuitry are included in the primary and secondary housings to enable intercommunication, such as a conventional FM transmitter/receiver. The respective housings may also be modified for hands free use of the cell phone, using an earpiece and speaker with microphone for voice activation.

### DESCRIPTION OF THE DRAWINGS

FIG. 1 shows an elevated, perspective view in partial cutaway section illustrating a combination-cell phone and PDA structured in accordance with the principles of the present invention.

FIG. 2 illustrates a cutaway view taken along the lines 2-2 of FIG. 1 exposing an interior view of a compartment portion of the invention.

### DETAILED DESCRIPTION OF THE INVENTION

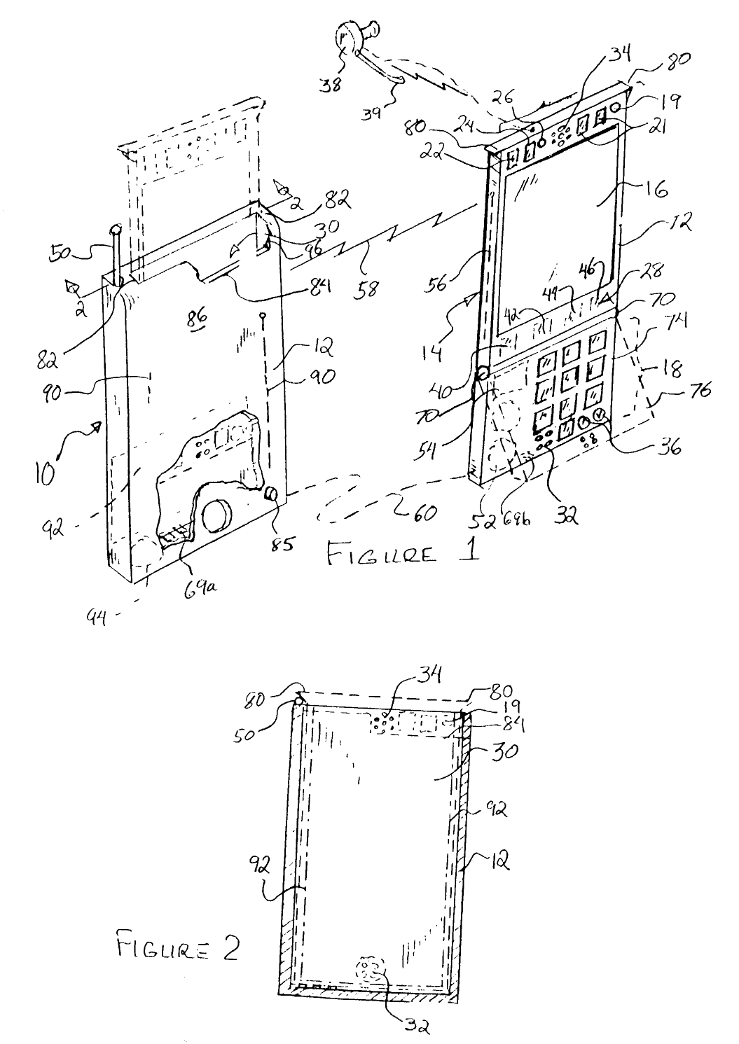

Referring now to FIGS. 1 and 2, the present invention is represented by a combination cell phone and PDA device 10. The device includes (i) a primary housing 12 for containment of a power source and primary control circuitry, and (ii) a secondary housing 14 including a display screen 16 and command input functions 18, 19, 22, 24, 26, 28 for telephone and PDA use. The primary housing includes a receiving opening and compartment 30 configured for removable insertion of the secondary housing for storage during nonuse, yet provides easy access for removal from the primary housing to expose the display screen, as well as to access communication features of the secondary housing for cell phone use, as well as PDA functions.

The secondary housing 14 provides the handheld phone and PDA console. Phone elements include customary telephone components such as a power switch 19, volume controls 21, microphone 32, ear speaker 34, numeric pad 18, up and down keys 36 and other function keys appropriate for control of cell phone features. Call information, function commands, and related output data are displayed on the common display 16. Hands free operation is provided with a separate earpiece 38 and microphone 39 which are coupled to the cell phone circuitry by wire or appropriate telemetry systems.

The PDA components include typical elements such as file keys for calendar 40, notes 42, phone numbers 44, library resources 46, etc. These are generally represented by function reference numeral 28, and could include any variety of function keys desired by the user. PDA switch 26 activates the console display and associated function keys. Data entry is entered on the display using a stylus 50, or other appropriate entry device in a conventional manner.

Because the console unit 14 primary includes only data entry and user interface components, rather than control circuitry, power pack, memory cells, etc., it has minimal weight and significantly reduced size. Indeed, the handheld console may be only one-quarter inch thick and weigh several ounces. This design provides the user with a very comfortable device capable of sustained use without strain.

Power requirements are supplied by light-weight batteries 52 that couple to the control circuitry 54 contained within the housing. For the wireless version, an antenna component 56 provides appropriate telemetry functions for send and receive operations. Phone and PDA data are transferred between the first and second housings by RF, IR or other appropriate media 58. Alternatively, a direct wire connection 60 may be used for data transfer between the housings. In addition, synchronization of data within the secondary housing with the primary processing system of the primary housing can be accomplished through RF, IR or with direct electrical contacts 69a and 69b on contacting surfaces of the receiving compartment and secondary housing. Such contacts could include aligned electrical contacts for enabling both power sharing for battery recharge, as well as data transport between the primary and secondary housing when the secondary housing is inserted within the receiving compartment.

A further embodiment of this invention includes a hinged junction 70 in a midsection of the secondary housing dividing the secondary housing into upper 72 and lower 74 sections. A preferred configuration positions the display screen 16 in the upper section and the telephone input functions in the lower section. This configuration allows rotation of the lower section 74 to an oblique angle 76 with respect to the upper section, placing the microphone 32 proximate to the mouth of the user for better reception of audio input.

The device is also characterized by laterally extending shoulders 80 at upper sides of the upper section of the secondary housing. These shoulders are configured to engage upper contacting edges 82 of the primary housing 12 to block further insertion into the compartment. In this manner, the console or secondary housing 14 seats within the compartment 30 in an elevated position, enabling ready grasp of either or both of the respective shoulders 80 to lift the console free of the insert slot or compartment 30. Alternatively, the console 14 could be spring-loaded within the compartment, and released by a release switch 85, allowing the console to pop free for use.

A window recess 84 is formed at a forward face 86 of the compartment and is configured to expose the telephone speaker 34 and microphone elements 32 when the console is fully inserted in the compartment. Power controls 19 and 21 may also be exposed, enabling activation of the telephone upon reception of a phone call. In this manner, the device may be used as a single unit for incoming calls, avoiding the need to remove the console from the compartment for limited phone use. This configuration allows one-hand use from a purse or tabletop, rather than requiring two hands to separate the console from the primary housing or case 12. Voice pickup is this seated configuration is accomplished through an opening 88 in a lower portion of the case, providing voice exposure to the microphone element 32.

The primary housing or case 12 provides a protective cover for the console 14, as well as housing for the control circuitry 92, battery pack 94, stylus 50, and reception antenna 96 for Internet and telephone signals. The control circuitry 92 includes all necessary data processing, memory, software and system requirements to drive both the cell phone and PDA operations. The battery pack not only powers the systems of the primary housing, but also supplies energy for charging the batteries 52 of the console unit 14.

The housing may also be configured with an open face as represented by phantom lines 90. In this configuration, all of the console operating elements are in open view for access, without the need for removal from the case. The user has the option of either carrying the device within a purse or pocket, and retaining the two components in a seated configuration during use; or mounting the case 12 with a clip to a belt or other support member attached to the user, and removing the console component during use.

Supporting control circuitry 70 and 92 in the respective console and case is well known and need not be disclosed in detail, as well as telemetry systems enabling hands-free use of the console from the case. Construction materials, display components and function controls for both the PDA and cell phone operations are consistent with those currently used within the industry for smartphone devices and/or separate PDA and cell phone systems, and do not require further explanation.

As mentioned above, an additional embodiment of the present invention provides for either wireless or hard-wired connection between the primary and secondary housings. For wireless applications, telemetry and receiver circuitry are included in the primary and secondary housings, such as a conventional FM, IR or other functional transmitter/receiver system. The same telemetry system may also be used to support the hands free earpiece 38 and microphone 39.

It will be apparent that other modifications and variations can be made applying the concepts of the present invention. Accordingly, the invention is not to be limited by embodiments set forth above, but should be construed in view of the following claims.

What is claimed is:

1. A combination cell phone and PDA device, comprising:
a primary housing for containment of a power source and primary control circuitry, including transmission and reception circuitry for a cellular telephone, and
a secondary housing including a display screen and command input functions and circuitry for both telephone and PDA use;
said primary housing including a receiving compartment configured for removable insertion of the secondary housing for storage during nonuse, thereby providing easy access for removal from the primary housing to access communication and processing features of the secondary housing for cell phone and PDA use.

2. A device as defined in claim 1, wherein said receiving compartment and secondary housing include aligned electrical contacts for enabling power sharing and data transport between the primary and secondary housing when the secondary housing is inserted within the receiving compartment.

3. A device as defined in claim 1, wherein the secondary housing further includes a hinged junction in a midsection of the secondary housing dividing the secondary housing into upper and lower sections, allowing rotation of the lower section to an oblique angle with respect to the upper section.

4. A device as defined in claim 2, wherein the display screen is positioned in the upper section and the telephone and PDA input functions are positioned in the lower section.

5. A device as defined in claim 1, further comprising laterally extending shoulders at upper sides of the upper section of the secondary housing configured to engage upper contacting edges of the primary housing to block full insertion of the secondary housing into the compartment, thereby enabling the console to be readily grasped by a user and removed from the compartment.

6. A device as defined in claim 1, further including a window recess formed at a forward face of the compartment and configured to expose telephone speaker and microphone elements, as well as power controls enabling activation of the telephone on upon reception of a phone call.

7. A device as defined in claim 1, further including a wired connection between the primary and secondary housings to provide intercommunication between the first primary and secondary housings.

8. A device as defined in claim 1, said primary and secondary housings further including telemetry and receiver circuitry enable wireless intercommunication.

9. A device as defined in claim 1, wherein the primary housing includes hands-free circuitry coupled to the control circuitry associated with cell phone functions, including an earpiece speaker and microphone for voice activation and communication.
